(19) United States
(12) Patent Application Publication
(10) Pub. No.: US 2015/0339659 A1
(43) Pub. Date: Nov. 26, 2015

(54) System And Method For Payment Credential-Based Mobile Commerce

(71) Applicant: Miguel Ballesteros, Roseville, CA (US)

(72) Inventor: Miguel Ballesteros, Roseville, CA (US)

(21) Appl. No.: 14/286,520

(22) Filed: May 23, 2014

(51) Int. Cl. G06Q 20/32; G06Q 20/38; G06Q 20/20

(52) U.S. Cl. CPC G06Q 20/3278; G06Q 20/204; G06Q 20/202; G06Q 20/3226; G06Q 20/3821; G06Q 20/38215

(57) ABSTRACT

In an embodiment, an apparatus comprises a security processor to perform a secure reader function to emulate an external near field communication (NFC) reader device, to obtain payment credential information of a user, a storage to store secure credential information of the user, and a NFC controller coupled to the security processor and the storage, responsive to initiation of the secure reader function, to disable a NFC contactless interface and to cause the payment credential information to be communicated to a remote system while the first contactless interface is disabled. Other embodiments are described and claimed.

### TECHNICAL FIELD

Embodiments relate to apparatus and techniques for secure processing of transactions.

### BACKGROUND

Near field communication (NFC)-based solutions are used with mobile devices to pay at a point of sale (POS) terminal as a direct replacement for a credit card or physical chip-based payment card. These solutions rely on NFC and EMV (Europay, MasterCard, Visa) technologies that are common in cellular telephones and contactless chip payment cards. EMV payment cards are recognized as a much higher security solution than traditional magnetic stripe payment cards such as a conventional credit card. While mobile devices having EMV credentials are typically used at a POS, such technologies are not readily adapted to other purchase models.

### BRIEF DESCRIPTION OF THE DRAWINGS

FIG. 1 is a block diagram of a portion of a device in accordance with an embodiment.

FIG. 2 is a sequence diagram for performing a mobile commerce transaction in accordance with an embodiment of the present invention.

FIG. 3 is a block diagram of a system in accordance with one embodiment of the present invention.

FIG. 4 is a flow diagram for a mobile commerce transaction method in accordance with another embodiment of the present invention.

FIG. 5 is a block diagram of a system arrangement in accordance with another embodiment of the present invention.

### DETAILED DESCRIPTION

Embodiments provide apparatus and techniques to securely and conveniently use EMV credentials available within a device such as a portable device for mobile commerce, in which a mobile device is used to access a website or application and perform a transaction to purchase goods/services and remotely execute a payment. More specifically, embodiments enable such commerce to be performed using a device including standard-compliant EMV credentials. Stated another way, currently available EMV credentials, complying with present and future standards such as one or more EMV specifications, e.g., in accordance with the Integrated Circuit Card Specifications for Payment Systems, version 4.3 (November 2011), can be used to perform mobile commerce via a wireless device.

A mobile wallet, which includes a set of personal financial-based data and embedded technology of a mobile device, relies in part on two components of the device to perform mobile commerce as described herein. These components include a NFC device that has a card emulation mode to emulate a contactless card communications interface and a security processor, also referred to herein as a secure element (SE), that is configured to operate as a smartcard chip. Note that in general, credentials stored in a mobile wallet can only be accessed over a contactless interface (namely a NFC interface) and not from a host (namely an application processor and its software) for security reasons. EMV credentials contain both public and private data, and while the private data is secured and reserved for actual transaction operations, the public data is sensitive in nature (account number, account holder name, expiration date) and in clear text, making it an attractive target for fraudsters were it accessible from host software (e.g., via malware operating on the application processor).

In some embodiments, a basic security model for EMV payment credential access in a mobile wallet can be applied for mobile commerce by emulating access to the EMV credentials via a contactless interface of the device. To this end, embodiments may provide an internal NFC reader function (that acts as an embedded mobile POS (mPOS) terminal). This internal function may be implemented within appropriate hardware, firmware, software and/or combinations thereof. In one embodiment, the function may be implemented in a security processor of the mobile device. In different implementations, this security processor may be a standalone hardware processor, a fixed function engine such as a security engine, or integrated within a system on chip (SoC) or other general purpose processor.

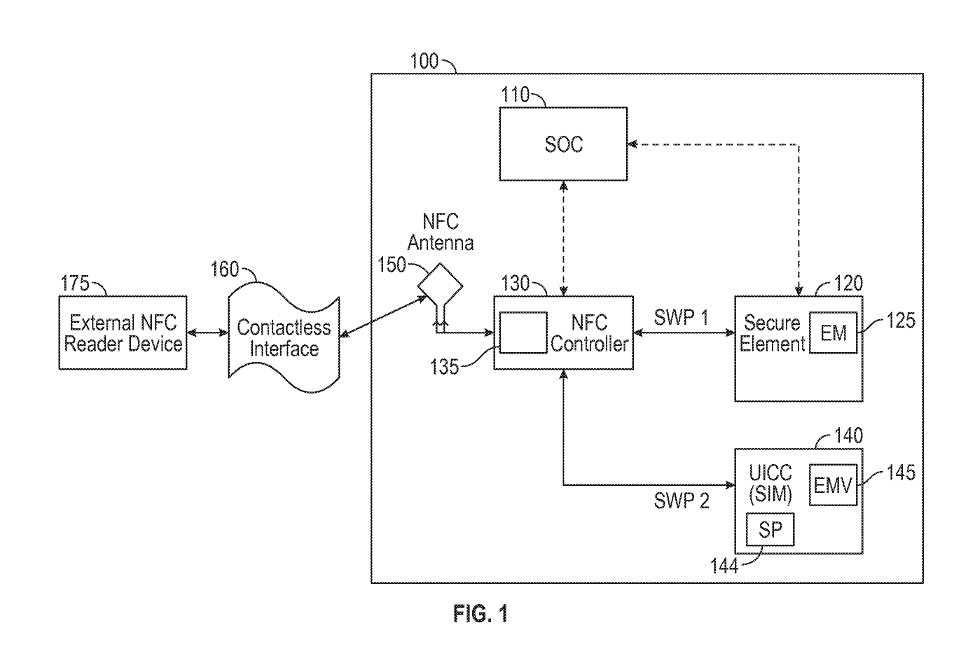

Referring now to FIG. 1, shown is a block diagram of a portion of a device in accordance with an embodiment. As shown in FIG. 1, device 100, which may be a mobile device such as smartphone, tablet computer, e-reader or other portable electronic device, includes a SoC 110 which may act as an application processor for device 100 to perform various applications on behalf of an end user. As seen, SoC 110 couples to a secure element (SE) 120, e.g., via an inter-integrated circuit (I²C) interconnect or a serial peripheral interface (SPI) interconnect. SE 120 may be a dedicated security processor. As such, this security processor may be configured as a separate component from SoC 110. In other embodiments, secure element 120 may be integrated within SoC 110.

As seen, secure element 120 includes an emulation module 125 which may be used to emulate a POS terminal. As described herein emulation module 125 may operate as a mobile POS terminal or device. In such situations, emulation module 125 performs a secure reader function to read secure information stored within device 100. In an embodiment, emulation module 125 may execute a mobile POS application that can be implemented as a collection of applets to be executed by a Java™-based operating system (OS). Of course, the mPOS device and its functionality may be performed using other combinations of hardware and software, in different embodiments.

Still referring to FIG. 1, an NFC controller 130 is further coupled both to SoC 110 and secure element 120. Although the scope of the present invention is not limited in this regard, the communication path or interconnect between SoC 110 and NFC 130 may be an I²C or SPI interconnect. NFC controller 130 may be a wireless communication interface to enable a radio frequency (RF) field to be set up to perform NFC-based wireless communications with corresponding NFC devices in close proximity to system 100. In turn, NFC controller 130 may couple to secure element 120 via a single wire protocol (SWP1) connection.

As further shown, NFC controller 130 also couples to a universal integrated circuit card (UICC) 140 (via a second SWP connection (SWP2)) which in an embodiment may comprise a subscriber identity module (SIM). As further seen, UICC 140 also includes a secure data store 145 in which EMV payment credentials may be stored. Of course understand that various other information may be stored in secure storage 145, which in various embodiments may be implemented as any desired type of non-volatile storage.

As further illustrated, UICC 140 includes a security processor logic 144, which may execute various security applications, including an EMV application (such as may be stored in non-volatile storage 145) to interact with EMV data by way of performing various cryptographic operations on the EMV data and transaction data. For example in an embodiment, the EMV application may be implemented as a collection of Java™ applets. Such EMV application may take the form, in some embodiments, of a mobile wallet that is used to interact with EMV data and transaction data, using a cryptoprocessor or other security processor of UICC 140 to perform various operations for a given transaction. As an example, the EMV data may include one or more security keys, in addition to other financial and identification information of a user. In turn, incoming transaction information, which may include a transaction identifier, merchant information, transaction amount and so forth, may be cryptographically processed using one or more of the keys to generate secure payment credential information such as a packet or digest that includes the transaction information and user (and user account) information hashed or otherwise cryptographically processed using one or more of the keys to thus generate a packet for communication to a merchant or other entity that in turn can seek to validate this message by interaction with an issuer of the keys, such as a financial institution or other card issuer that provides the EMV data for a given user/customer.

Still referring to FIG. 1, NFC controller 130 couples to an antenna 150 such as a NFC antenna that enables communication with various wireless devices. For purposes of discussion here assume that for typical contactless payment in a retail situation, mobile device 100 may be in contactless communication with an external NFC reader device 175 such as implemented within a POS terminal. As such, a contactless interface 160 is realized between antenna 150 and external NFC reader 175. While mobile device 100 enables payment operations using EMV payment credentials stored in UICC 140 via contactless interface 160, understand that in a mobile commerce transaction in accordance with an embodiment, contactless interface 160 may be disabled, e.g., via NFC controller 130, as described further herein. Understand that these mobile commerce transactions may be online transactions between a mobile device and an online merchant, termed herein as an “online mobile transaction.”

In an embodiment, when an EMV payment credential within device 100 (e.g., embedded within UICC 140) is to be used for purposes of a NFC transaction with a locally available reader device 175 (such as a POS terminal), NFC controller 130 configures, via a router logic 135, the data flow to be between external NFC reader device 175 and UICC 140 such that on proper verification or validation, requested payment information stored in secure data storage 145 may be communicated via contactless interface 160 to external NFC reader device 175.

Instead, when the EMV payment credential is to be used for purposes of an online mobile commerce transaction, the data flow is not via this contactless interface 160, which router logic 135 disables during such mobile commerce transaction. Instead, a data flow may be between the EMV payment credential stored in UICC 140 and a remote merchant (not shown in FIG. 1). Such communication may be configured via router logic 135 of NFC controller 130 to be between UICC 140 and secure element 120, and thereafter SoC 110 and via another wireless interface of mobile device 100 (not shown for ease of illustration in FIG. 1) such as of a given cellular (e.g., 3G or 4G) or other wireless communication protocol (e.g., a wireless local area network (WLAN) in accordance with a given Institute of Electrical and Electronics Engineers (IEEE) 802.11 specification).

In this mobile commerce-based data flow, SE 120, via emulation logic 125, emulates an external NFC reader device (e.g., device 175) when secure element 120 establishes an internal NFC reader mode session terminated by UICC 140 operating in the NFC card emulation mode.

This function is equivalent to an external POS terminal and may be used to initiate an NFC reader mode session marked as internal only so that NFC controller 130 prevents contactless interface 160 from being activated. Instead, NFC controller 130, via an internal interface, routes internally to anther NFC node (e.g., UICC 140) that invokes an NFC card emulation mode session. In this way, EMV payment credentials are made available for payment transactions to an internal POS device. NFC controller 130, via router logic 135, thus acts as router and connects UICC 140 to SE 120 (more specifically to enable the EMV data to be provided to emulation logic 125) as if an external NFC reader device had been detected via contactless interface 160.

Thus a mobile wallet is integrated for mobile commerce usages via an internal mPOS terminal integrated into the device itself. Stated another way, both the mobile wallet and mPOS are present within the mobile device. Assume that a merchant is an online merchant. The interactions take place between UICC 140 and SE 120 via NFC controller 130, instead of any interaction with an external POS terminal. From the integrated mPOS perspective, SE 120 invokes a NFC reader mode marked as EMULATED so that NFC controller 130 operates to detect an internal NFC node operating in the card emulation NFC mode, as opposed to an external NFC card target. As such, contactless interface 160 is not activated at any time.

Once the mobile wallet is activated and UICC 140 invokes the card emulation NFC mode, NFC controller 130 connects SE 120 and UICC 140, where the EMV credentials are stored. Thereafter, the EMV transaction begins. At the end of the EMV transaction, the SE deactivates the UICC (including the card being emulated), and terminates the NFC reader mode. Finally the online merchant and user are notified of the payment processing completion. From the mobile wallet perspective, there is no difference between an external POS case and this case.

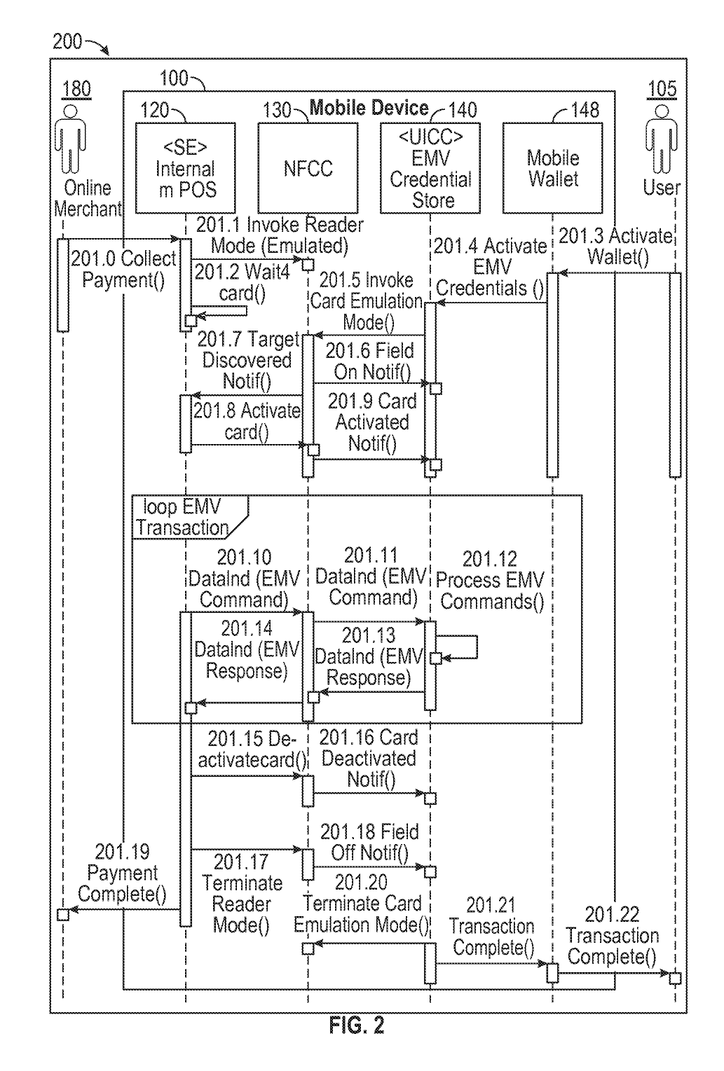

Referring now to FIG. 2, shown is a sequence diagram for performing a mobile commerce transaction in accordance with an embodiment of the present invention. As shown in FIG. 2, sequence 200 may be used to perform a mobile commerce transaction between a merchant 180, e.g., an online merchant, and a user 105 of a mobile device 100, which may be configured as shown in FIG. 1. Understand that while a particular information flow is shown in the illustration of FIG. 2, many variations and alternatives are possible. For the mobile commerce transaction, assume that user 105 has accessed a website of merchant 180 in order to purchase a good or service. At a checkout user interface (e.g., a graphical user interface (GUI)), user 105 is requested to input a type of payment method, such as credit card, PayPal™ account, or so forth. Assume for purposes of an embodiment an additional payment method, namely an EMV-based method such as a mobile wallet, is selected. As a result, online merchant 180 (or a payment collection service with which merchant 180 has pre-arranged for handling payment for online transactions) may issue a collect payment request (201.0). Note that as used herein, the term “remote merchant” is collectively used to identify both a remote online (or other remote merchant) as well as any third party entity with whom the merchant has engaged in a payment collection arrangement.

Upon receipt within mobile device 100, e.g., via a given wireless interface such as a 3G/4G connection or other wireless interface, the request is provided to secure element 120, and more specifically to an internal mPOS function executing within SE 120, e.g., an emulation logic 125. In turn, SE 120 generates an emulated invoke reader mode request to NFC controller 130 (201.1) and enters a wait state (201.2). Note the emulated request thus indicates to NFC controller that the transaction is to proceed internally, and as such NFC controller 130 does not enable a contactless interface of the mobile device.

Still referring to FIG. 2, as part of the mobile commerce transaction, user 105 issues a wallet activation request (201.3) to a mobile wallet 148 which may be one or a set of applications executing on hardware of mobile device 100 (e.g., executing within a cryptoprocessor of UICC 140, which further includes a data store for EMV credentials). As seen, mobile wallet 148 generates an EMV credential activation request (201.4) that in turn causes UICC 140 to invoke a card emulation mode (201.5) which in turn triggers NFC controller 130 to notify UICC 140 of a field detected event (201.6). Note that this field detected notification is a masquerade, in that no NFC field is established due to the presence of the internal mPOS device such that no EMV data is subject to attack by NFC communication.

In turn, NFC controller 130 issues a notification of target discovery (201.7) to SE 120, which in turn generates an activate card request (201.8), which causes NFC controller 130 to generate a card activation notification to UICC 140 (201.9).

Thus a valid secure session is established between UICC 140 and SE 120 such that secure communications (generally 201.10-201.14) occur between these two devices to perform processing of the payment transaction including receiving transaction information, processing this information using EMV data (including a secure key) and providing secure data, e.g., a message digest to SE 120, at the end of which merchant 180 is notified of the completion of the payment cycle (201.19). Various communications to internal nodes (generally 201.15-201.18) may then occur to deactivate the emulated card mode and emulated NFC reader mode and communicate completion of transaction to end user 105 and remote merchant 180 (generally 201.19-201.22). Although shown at this high level in the embodiment of FIG. 2, understand the scope of the present invention is not limited in this regard.

Note that in other embodiments, both mobile wallet functionality and mPOS functionality may be implemented within a single component (e.g., secure element 120 or UICC 140). In such embodiments, the processing, including the appropriate coupling and NFC disabling controlled by NFC controller 130 still may occur. In still different variations of such embodiments, the component having both mobile wallet and NFC reader functionality can internally perform a mobile commerce transaction even without participation from NFC controller 130 (i.e., the EMV transaction happens directly and internally between the wallet application and mPOS without interfacing with the NFC controller).

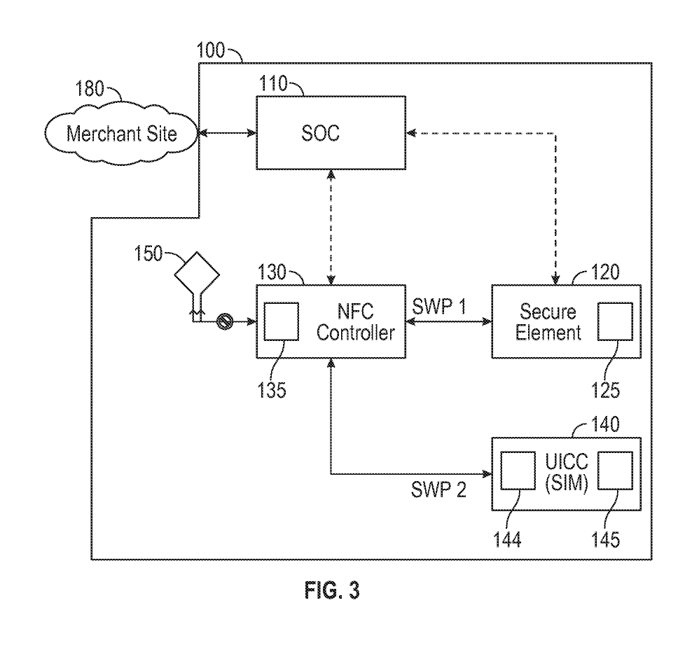

A final end-to-end solution between a user and a remote merchant is shown in FIG. 3, which is a block diagram of a system in accordance with another embodiment. As seen, a merchant site 180 interacts with SE 120 (including an integrated mPOS implemented within emulation logic 125) to collect payment using EMV payment credentials (e.g., stored within UICC 140). The EMV credentials are processed by SE 120 (in its emulation logic 125 mPOS function) internally over the internal emulated NFC network without activating a NFC contactless interface.

Note that in an embodiment, SE 120 (which implements the integrated mPOS terminal) utilizes a standard NFC reader mode protocol with only one exception: an indicator such as a flag is provided to indicate to NFC controller 130 that the reader mode invoked is to emulate an external NFC reader device toward internal NFC nodes. Other than that, the NFC reader mode protocol is unchanged, in an embodiment. Note that NFC controller 130 may be configured to redirect NFC traffic internally from the SE (acting as the NFC reader) and the UICC (acting as the NFC card) and vice-versa, and to disable a NFC contactless interface (e.g., by disabling NFC antenna 150).

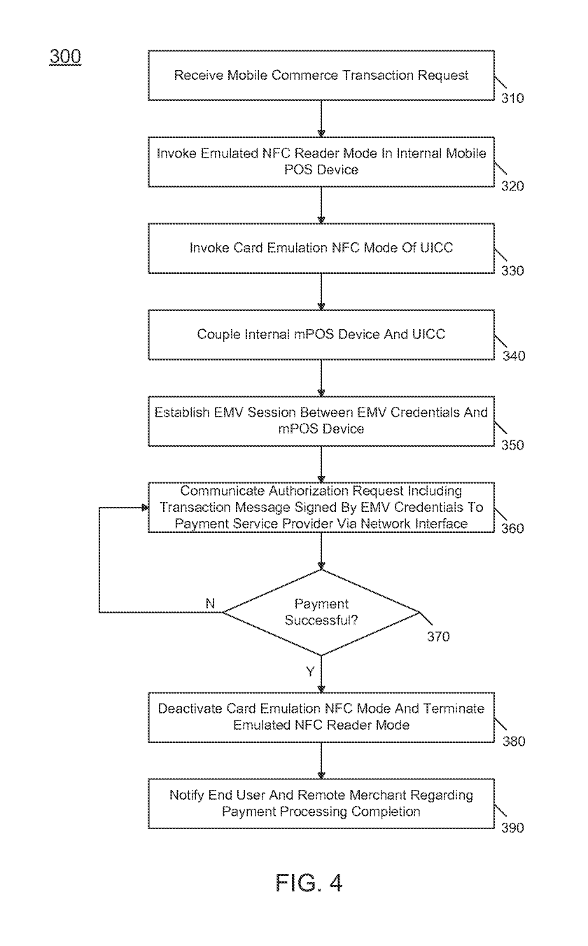

Referring now to FIG. 4, shown is a flow diagram for a mobile commerce transaction method in accordance with another embodiment of the present invention. As shown in FIG. 4, method 300 may be performed using various hardware and logic within a mobile device, as well as backend hardware both of a remote merchant, such as an online merchant from which a user of the mobile device desires to purchase a good or service, as well as possibly a payment service provider associated with this remote merchant (and which may be coupled to hardware of the remote merchant via one more backend networks). As seen, method 300 begins by receiving a mobile commerce transaction request (block 310). This request may be triggered by a user accessing a website of the remote merchant in performing a checkout operation with a choice of payment method by mobile wallet or other mobile-based payment direction. Responsive to this request (when received in the mobile device), an emulated NFC reader mode is invoked in an internal mobile POS device (block 320). And a card emulation NFC mode of a UICC or other device that includes EMV data and an associated cryptoprocessor may be invoked as well (block 330). Responsive to these invocations, the internal mPOS device and the UICC may be coupled (block 340). By this coupling, an EMV session, which is a secure session to enable communication of transaction and EMV data, may occur. Thus at block 350 an EMV session is established between an EMV-based application and an mPOS application (both of which may execute on various hardware of the mobile device).

Still referring to FIG. 4, responsive to this EMV session establishment and data communication between the coupled components, an authorization request may be sent to a payment service provider via a network interface (block 360). Note that this network interface may be by a given wireless interface of the mobile device such as a 3G or 4G network interface and not via a NFC interface. This authorization request may include, in an embodiment, a transaction message. More specifically, this message may be a signed message that is signed by one or more EMV credentials such as one or more public or private keys of the user provided by an issuer. Control next passes to diamond 370 to determine whether payment was successful. Such successful payment determination may occur when the payment service provider verifies the transaction message as valid using the same one or more keys used to generate the transaction message. Note that this successful validation is also predicated upon the user having a valid account as verified by the payment service provider and sufficient funds and/or credit to cover the transaction cost.

On successful payment, the emulation modes are deactivated (block 380) and the end users (namely the mobile device user and the remote merchant) are notified of the successful transaction completion such that the remote merchant may enable transfer of the goods or services. Although shown at this high level in the FIG. 4 embodiment, the scope of the present invention is not limited in this regard.

By using an embodiment of the present invention, EMV credentials stored in a mobile wallet of a mobile or other device can be conveniently and securely used for mobile commerce (such as online transactions using a mobile device). Further such EMV credentials can be used in embodiments without: reducing available security profile mechanisms for contactless EMV payment credentials; modification to existing contactless EMV standards and/or contactless EMV credential smartcard application implementations from credit card companies, banks, and other financial institutions.

Embodiments also leverage an embedded POS terminal in the device itself instead of requiring an external POS terminal device such that available EMV application/credentials need not be modified, as from the point of view of the application/credential it interacts with a POS terminal (either external or internal). As such, embodiments may seamlessly integrate use of EMV credentials already present in a mobile wallet or other wireless or other device into a mobile commerce framework, removing the limitation of in-store POS usage only. Still further, security and convenience of mobile commerce is enhanced as for an end user, it is no longer necessary to access a physical wallet to remove a payment card to complete an online transaction, while maintaining the level of security of EMV has already defined while extending it into the mobile commerce world. In this way, embodiments provide a mechanism to interface with EMV payment credentials within a mobile wallet solution in a way that is transparent to the current mobile wallet operation.

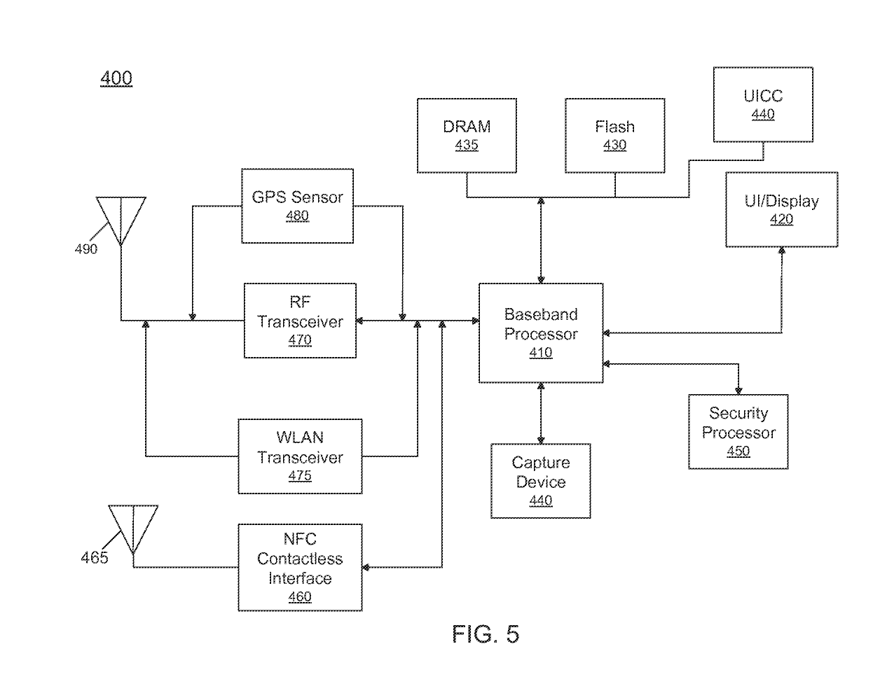

Referring now to FIG. 5, shown is a block diagram of an example system 400 with which embodiments can be used. As seen, system 400 may be a smartphone or other wireless communicator. As shown in the block diagram of FIG. 5, system 400 may include an application or baseband processor 410. In general, baseband processor 410 can perform various signal processing with regard to communications, as well as perform computing operations for the device. In turn, baseband processor 410 can couple to a user interface/display 420 which can be realized, in some embodiments by a touch screen display that can display a secure checkout webpage of a remote online merchant to enable the NFC-encrypted payment processing described herein. In addition, baseband processor 810 may couple to a memory system including, in the embodiment of FIG. 5, a non-volatile memory, namely a flash memory 430 and a system memory, namely a dynamic random access memory (DRAM) 435. As further seen, baseband processor 410 can further couple to a capture device 440 such as an image capture device that can record video and/or still images.

Still referring to FIG. 5, a UICC 440 is also coupled to baseband processor 410. As discussed herein UICC 440 may include a storage to store various secure information of a user including secure financial information and may further include a cryptoprocessor.

Also included in system 400 is a security processor 450 that may couple to baseband processor 410. In the embodiment shown, security processor 450 is a separate component of the system, however understand that the various security operations performed by security processor 450 instead can be performed in baseband processor 410 and/or a cryptoprocessor of UICC 440. Note that in some implementations, both a mPOS device implemented using an emulated NFC reader mode function and a mobile wallet application having EMV credentials may execute wholly within security processor 450.

As further illustrated, an NFC contactless interface 460 is provided that communicates in a NFC near field via an NFC antenna 465. While separate antennae are shown in FIG. 5, understand that in some implementations one antenna or a different set of antennae may be provided to enable various wireless functionality.

To enable communications to be transmitted and received, various circuitry may be coupled between baseband processor 410 and an antenna 490. Specifically, a radio frequency (RF) transceiver 470 and a wireless local area network (WLAN) transceiver 475 may be present. In general, RF transceiver 470 may be used to receive and transmit wireless data and calls according to a given wireless communication protocol such as 3G or 4G wireless communication protocol such as in accordance with a code division multiple access (CDMA), global system for mobile communication (GSM), long term evolution (LTE) or other protocol. In addition a GPS sensor 480 may be present. Other wireless communications such as receipt or transmission of radio signals, e.g., AM/FM and other signals may also be provided. In addition, via WLAN transceiver 475, local wireless signals, such as according to a Bluetooth™ standard or an IEEE 802.11 standard such as IEEE 802.11a/b/g/n can also be realized. Note that for performing secure mobile transactions with a remote online merchant, actual communications of a financial transaction may occur via one of these transceivers 470 and 475, rather than NFC contactless interface 460, to provide enhanced security and enable such transactions. Although shown at this high level in the embodiment of FIG. 5, understand the scope of the present invention is not limited in this regard.

The following examples pertain to further embodiments.

In Example 1, an apparatus comprises: a security processor including a first logic to perform a secure reader function to emulate an external NFC reader device, to obtain payment credential information of a user of the apparatus; a UICC including a storage to store secure credential information of the user; and a NFC controller coupled to the security processor and the UICC, responsive to initiation of the secure reader function, to disable a NFC contactless interface of the apparatus and to cause the payment credential information to be communicated to a remote system while the NFC contactless interface is disabled.

In Example 2, the apparatus of Example 1 further includes a second wireless interface to provide the payment credential information obtained from the UICC via the security processor to a remote merchant, to perform an online mobile commerce transaction.

In Example 3, the first logic is optionally to initiate the secure reader function responsive to a payment collection request from the remote merchant.

In Example 4, the first logic is optionally to set an emulation indicator to indicate to the NFC controller that the secure reader function is in an emulation mode in which the secure reader function is to be a recipient of the payment credential information.

In Example 5, the apparatus of any one of Examples 1-4 further includes a second security processor to execute a mobile wallet application stored in a storage of the apparatus and initiated by the user, wherein the mobile wallet application is to generate a request to activate a secure session responsive to the user initiation.

In Example 6, the NFC controller is to couple the UICC to the second security processor to enable the first logic to establish the secure session between the UICC and the second security processor.

In Example 7, the apparatus of one of Examples 5 and 6 comprises a system on a chip including the security processor and the second security processor.

In Example 8, the first and second security processors of one of Examples 5-7 comprise a single security processor.

In Example 9, the UICC optionally includes a secure cryptoprocessor to generate the payment credential information comprising a signed message including transaction information for the mobile commerce transaction and user financial information, and signed by at least a portion of the secure credential information, the secure credential information comprising a key stored in the UICC and provided by an issuer on behalf of the user.

In Example 10, the apparatus of Example 2 includes a display to display a GUI of the remote merchant, the GUI including a checkout area having a user-selectable area to be activated by the user to enable the online mobile commerce transaction.

In Example 11, the apparatus of Example 1 further includes the NFC contactless interface, where in a NFC mode, the NFC controller is to enable communication of the payment credential information from the UICC to an external NFC reader located in a near field with the apparatus via the NFC contactless interface.

In Example 12, at least one computer readable medium includes instructions that when execute enable a system to: receive a mobile commerce transaction request, and responsive thereto, invoke an emulated NFC reader mode in an internal mobile POS device of the system; invoke a card emulation NFC mode of a secure cryptoprocessor of the system; and couple the internal mobile POS device and the secure cryptoprocessor to enable the internal mobile POS device to participate in a secure session with the secure cryptoprocessor to receive an encrypted mobile commerce transaction packet encrypted with a secure key of secure payment credential information stored in a secure data store of the system, while a NFC contactless interface of the system is disabled.

In Example 13, the at least one computer readable medium of Example 12 includes instructions further to enable the system to communicate the encrypted mobile commerce transaction packet to a remote merchant via a wireless interface of the system.

In Example 14, the at least one computer readable medium of Example 12 further comprises instructions to enable the system to deactivate the card emulation NFC mode of the secure cryptoprocessor responsive to successful completion of the mobile commerce transaction.

In Example 15, the at least one computer readable medium of Example 14 further comprises instructions to enable the system to terminate the emulated NFC reader mode responsive to the successful completion of the mobile commerce transaction.

In Example 16, the at least one computer readable medium of Example 15 further comprises instructions to enable the system to notify a user of the system about the successful completion of the mobile commerce transaction.

In Example 17, the internal mobile POS device and secure cryptoprocessor of any one of Examples 12-16 are to execute at least some of the instructions on a processor of the system.

In Example 18, a system comprises: an application processor to execute user applications; a security processor coupled to the application processor and including an emulation logic to emulate an external NFC reader device to obtain a transaction message signed by a credential of a user of the system; a secure storage to store the credential and account information of the user with respect to at least one issuer entity; a NFC contactless interface to enable wireless communication with a NFC device in a near field with the system; a cryptographic logic coupled to the secure storage to generate the transaction message based on the credential, at least a portion of the account information, and transaction information for a mobile commerce transaction between the user and a remote entity; and a NFC controller coupled to the security processor, the secure storage, and the NFC contactless interface, responsive to initiation of the emulation logic, to disable the NFC contactless interface and to enable the transaction message to be communicated to a remote system associated with the remote entity while the NFC contactless interface is disabled.

In Example 19, the system of Example 18 further comprises a wireless interface to provide the transaction message to the remote system, to complete the mobile commerce transaction, where the wireless interface is coupled to receive the transaction message via the application processor.

In Example 20, the emulation logic is optionally to set an emulation indicator to indicate to the NFC controller that the emulation logic is to be a recipient of the transaction message.

In Example 21, the security processor is optionally to execute a mobile wallet application to generate a request to activate a secure session using the credential.

In Example 22, in a system of any one of Examples 18-21, in a NFC mode, the NFC controller is optionally to enable communication of at least a portion of the account information to an external NFC reader device located in the near field with the system via the NFC contactless interface.

In Example 23, a system comprises: means for receiving a mobile commerce transaction request, and responsive thereto, invoking an emulated NFC reader mode in an internal mobile POS means of the system; means for invoking a card emulation NFC mode of a secure cryptoprocessor means of the system; and means for coupling the internal mobile POS means and the secure cryptoprocessor means to enable the internal mobile POS means to participate in a secure session with the secure cryptoprocessor means to receive an encrypted mobile commerce transaction packet encrypted with a secure key of secure payment credential information stored in a secure data store of the system, while a NFC contactless interface of the system is disabled.

In Example 24, the system of Example 23 further comprises means for communicating the encrypted mobile commerce transaction packet to a remote merchant via a wireless interface of the system.

In Example 25, the system of Example 24 further comprises means for deactivating the card emulation NFC mode of the secure cryptoprocessor means responsive to successful completion of the mobile commerce transaction.

In Example 26, the system of Example 24 further comprises: means for terminating the emulated NFC reader mode responsive to successful completion of the mobile commerce transaction; and means for notifying a user of the system about the successful completion of the mobile commerce transaction.

In Example 27, a method comprises: receiving a mobile commerce transaction request, and responsive thereto, invoking an emulated NFC reader mode in an internal mobile POS device of a system; invoking a card emulation NFC mode of a secure cryptoprocessor of the system; and coupling the internal mobile POS device and the secure cryptoprocessor to enable the internal mobile POS device to participate in a secure session with the secure cryptoprocessor to receive an encrypted mobile commerce transaction packet encrypted with a secure key of secure payment credential information stored in a secure data store of the system, while a NFC contactless interface of the system is disabled.

In Example 28, the method of Example 27 further comprises communicating the encrypted mobile commerce transaction packet to a remote merchant via a wireless interface of the system.

In Example 29, the method of Example 28 further comprises deactivating the card emulation NFC mode of the secure cryptoprocessor responsive to successful completion of the mobile commerce transaction.

In Example 30, the method of Example 29 further comprises terminating the emulated NFC reader mode responsive to successful completion of the mobile commerce transaction.

In Example 31, the method of Example 30 further comprises notifying a user of the system about the successful completion of the mobile commerce transaction.

In Example 32, a machine-readable storage medium includes machine-readable instructions, when executed, to implement a method of any one of Examples 27-31.

In Example 33, an apparatus comprises means to perform a method of any one of Examples 27-31.

Understand that various combinations of the above examples are possible.

Embodiments may be used in many different types of systems. For example, in one embodiment a communication device can be arranged to perform the various methods and techniques described herein. Of course, the scope of the present invention is not limited to a communication device, and instead other embodiments can be directed to other types of apparatus for processing instructions, or one or more machine readable media including instructions that in response to being executed on a computing device, cause the device to carry out one or more of the methods and techniques described herein.

Embodiments may be implemented in code and may be stored on a non-transitory storage medium having stored thereon instructions which can be used to program a system to perform the instructions. The storage medium may include, but is not limited to, any type of disk including floppy disks, optical disks, solid state drives (SSDs), compact disk read-only memories (CD-ROMs), compact disk rewritables (CD-RWs), and magneto-optical disks, semiconductor devices such as read-only memories (ROMs), random access memories (RAMs) such as dynamic random access memories (DRAMs), static random access memories (SRAMs), erasable programmable read-only memories (EPROMs), flash memories, electrically erasable programmable read-only memories (EEPROMs), magnetic or optical cards, or any other type of media suitable for storing electronic instructions.

While the present invention has been described with respect to a limited number of embodiments, those skilled in the art will appreciate numerous modifications and variations therefrom. It is intended that the appended claims cover all such modifications and variations as fall within the true spirit and scope of this present invention.

What is claimed is:

1. An apparatus comprising:
a security processor including a first logic to perform a secure reader function to emulate an external near field communication (NFC) reader device, to obtain payment credential information of a user of the apparatus;
a universal integrated card circuit (UICC) including a storage to store secure credential information of the user; and
a NFC controller coupled to the security processor and the UICC, responsive to initiation of the secure reader function, to disable a NFC contactless interface of the apparatus and to cause the payment credential information to be communicated to a remote system while the NFC contactless interface is disabled.

2. The apparatus of claim 1, further comprising a second wireless interface to provide the payment credential information obtained from the UICC via the security processor to a remote merchant, to perform an online mobile commerce transaction.

3. The apparatus of claim 2, wherein the first logic is to initiate the secure reader function responsive to a payment collection request from the remote merchant.

4. The apparatus of claim 1, wherein the first logic is to set an emulation indicator to indicate to the NFC controller that the secure reader function is in an emulation mode in which the secure reader function is to be a recipient of the payment credential information.

5. The apparatus of claim 1, further comprising a second security processor to execute a mobile wallet application stored in a storage of the apparatus and initiated by the user, wherein the mobile wallet application is to generate a request to activate a secure session responsive to the user initiation.

6. The apparatus of claim 5, wherein the NFC controller is to couple the UICC to the second security processor to enable the first logic to establish the secure session between the UICC and the second security processor.

7. The apparatus of claim 5, wherein the apparatus comprises a system on a chip including the security processor and the second security processor.

8. The apparatus of claim 5, wherein the first security processor and the second security processor comprise a single security processor.

9. The apparatus of claim 2, wherein the UICC includes a secure cryptoprocessor to generate the payment credential information comprising a signed message including transaction information for the mobile commerce transaction and user financial information, and signed by at least a portion of the secure credential information, the secure credential information comprising a key stored in the UICC and provided by an issuer on behalf of the user.

10. The apparatus of claim 2, further comprising a display to display a graphical user interface (GUI) of the remote merchant, the GUI including a checkout area having a user-selectable area to be activated by the user to enable the online mobile commerce transaction.

11. The apparatus of claim 1, further comprising the NFC contactless interface, wherein in a NFC mode, the NFC controller is to enable communication of the payment credential information from the UICC to an external NFC reader located in a near field with the apparatus via the NFC contactless interface.

12. At least one computer readable medium including instructions that when execute enable a system to:
receive a mobile commerce transaction request, and responsive thereto, invoke an emulated near field communication (NFC) reader mode in an internal mobile point of sale (POS) device of the system;
invoke a card emulation NFC mode of a secure cryptoprocessor of the system; and
couple the internal mobile POS device and the secure cryptoprocessor to enable the internal mobile POS device to participate in a secure session with the secure cryptoprocessor to receive an encrypted mobile commerce transaction packet encrypted with a secure key of secure payment credential information stored in a secure data store of the system, while a NFC contactless interface of the system is disabled.

13. The at least one computer readable medium of claim 12, wherein the instructions further enable the system to communicate the encrypted mobile commerce transaction packet to a remote merchant via a wireless interface of the system.

14. The at least one computer readable medium of claim 12, further comprising instructions that when executed enable the system to deactivate the card emulation NFC mode of the secure cryptoprocessor responsive to successful completion of the mobile commerce transaction.

15. The at least one computer readable medium of claim 14, further comprising instructions that when executed enable the system to terminate the emulated NFC reader mode responsive to the successful completion of the mobile commerce transaction.

16. The at least one computer readable medium of claim 15, further comprising instructions that when executed enable the system to notify a user of the system about the successful completion of the mobile commerce transaction.

17. The at least one computer readable medium of claim 12, wherein the internal mobile POS device and the secure cryptoprocessor are to execute at least some of the instructions on a processor of the system.

18. A system comprising:
an application processor to execute user applications;
a security processor coupled to the application processor and including an emulation logic to emulate an external near field communication (NFC) reader device to obtain a transaction message signed by a credential of a user of the system;
a secure storage to store the credential and account information of the user with respect to at least one issuer entity;
a NFC contactless interface to enable wireless communication with a NFC device in a near field with the system;
a cryptographic logic coupled to the secure storage to generate the transaction message based on the credential, at least a portion of the account information, and transaction information for a mobile commerce transaction between the user and a remote entity; and
a NFC controller coupled to the security processor, the secure storage, and the NFC contactless interface, responsive to initiation of the emulation logic, to disable the NFC contactless interface and to enable the transaction message to be communicated to a remote system associated with the remote entity while the NFC contactless interface is disabled.

19. The system of claim 18, further comprising a wireless interface to provide the transaction message to the remote system, to complete the mobile commerce transaction, wherein the wireless interface is coupled to receive the transaction message via the application processor.

20. The system of claim 18, wherein the emulation logic is to set an emulation indicator to indicate to the NFC controller that the emulation logic is to be a recipient of the transaction message.

21. The system of claim 18, wherein the security processor is to execute a mobile wallet application, the mobile wallet application to generate a request to activate a secure session using the credential.

22. The system of claim 18, wherein in a NFC mode, the NFC controller is to enable communication of at least a portion of the account information to an external NFC reader device located in the near field with the system via the NFC contactless interface.
